(19) United States
(12) Patent Application Publication
(10) Pub. No.: US 2022/0201442 A1
(43) Pub. Date: Jun. 23, 2022

(54) METHOD AND APPARATUS FOR ENHANCING THE VALUE OF VEHICULAR DATA USING V2X COMMUNICATIONS

(71) Applicant: AUTOTALKS LTD., Kfar Netter (IL)

(72) Inventor: Onn Haran, Bnei Dror (IL)

(21) Appl. No.: 17/372,438

(22) Filed: Jul. 10, 2021

Related U.S. Application Data
(60) Provisional application No. 63/131,088, filed on Dec. 28, 2020.
(60) Provisional application No. 63/130,031, filed on Dec. 23, 2020.

(51) Int. Cl. H04W 4/40; H04L 29/08

(52) U.S. Cl. CPC H04W 4/40; H04L 67/10

(57) ABSTRACT

Methods and apparatus that enhance self-vehicle data using other V2X data to provide relevant data for different use-cases. The apparatus may include a V2X communication unit configured to receive V2X data from another vehicle, a combined data processor configured to process the self-vehicle data and the V2X data into combined data and to extract relevant data from the combined data, the relevant data relevant to the use-case, and a cloud communication unit configured to transmit the relevant data to a cloud. Optionally, the apparatus may also include false-negative, false-positive and accident logs for logging the relevant data before transmitting the relevant data to the cloud.

### CROSS-REFERENCE TO RELATED APPLICATIONS

This application is related to and claims the priority benefit of U.S. Provisional Patent Applications Nos. 63/130,031 filed Dec. 23, 2020 and 63/131,088 filed Dec. 28, 2020, which are incorporated herein by reference in their entirety.

### FIELD

Embodiments disclosed herein relate generally to enhancing the value of vehicular data using vehicle-to-everything (V2X) communication (or simply “V2X).

### BACKGROUND

While driving, a vehicle generates a lot of data, such as location, speed, acceleration, sensors raw data and perception decisions. A vehicle's self generated data (obtained e.g. by onboard sensors) may be referred to henceforth as “self-vehicle data” or “self-data”. Data monetization services highlight a variety of data usages for multiple different end-customer types, such as the OEMs, municipalities, and different businesses.

The self-vehicle data can be classified into four different categories: location of the self-vehicle, status of the self-vehicle, operation of the self- vehicle, and actions of the self-vehicle driver. The first two data categories are valuable for multiple use-cases and require only the self-vehicle data. However, self-vehicle data are nearly meaningless in the two other categories if actions or data of other vehicles are not considered. Furthermore, mining (also called “identification”) of relevant data from the self-vehicle data collected for the duration of an entire driving cycle is cumbersome.

For example, vehicle sensors may occasionally fail to properly detect and classify all road objects. In some cases, an object would be missed, creating a false-negative failure, and in other cases, a non-existing object would be detected, creating a false-positive failure. Carmakers and their supply chains are attempting to isolate the false-positive and false-negative sensor failures to train machine learning algorithms with the correct operation. Some vendors record the raw data of sensors and upload it to a cloud environment (or simply “cloud”) for offline labeling and machine learning algorithm retraining.

Processing a huge amount of data are expensive, but the greatest challenge is the identification of failures. An algorithm that fails in a vehicle will not be able to properly identify a failure in a cloud environment, therefore, humans have to be involved in the process. However, human capacity is limited, and cannot scale to analyze all recorded data. Therefore, screening of the sensor data should be performed automatically, and a human should handle only data where concrete failures are suspected.

It would be desirable to to find ways to expand vehicle data to provide more details on sensor failures and accident scenes, as well as on other use-cases. It would be desirable to to mine data relevant to such use-cases with minimal human assistance.

### SUMMARY

The disclosure provides embodiments of methods and apparatus that enhance self-vehicle (or “local”) data using other data received through V2X communications (referred to henceforth as “V2X data”) to include categories of operation of the vehicle and actions of the driver. This enhancement can also be referred to as “vehicular data enhancement using V2X”. The V2X data are provided by other vehicles or other entities that are in V2X communication with the self-vehicle. The combination of self-vehicle data and V2X data is referred to herein as “combined data” or “enhanced data”.

Assume for example that the V2X data are received at the self-vehicle from a nearby (“other” or “another”) vehicle. As with the self-data, the combined data (from the combination of the self-data with the nearby vehicle transmitted V2X data) can be classified for example into four different categories: locations of the self-vehicle and the nearby vehicle, status of the self-vehicle and the nearby vehicle, operation of the self-vehicle, and actions of the self-vehicle driver and nearby vehicle driver. The content of data in each category will be broader for the combined data than for the self-vehicle data alone. The combined data may be analyzed and mined to identify “relevant” data. The relevant data may be provided to relevant interested customers (for example insurance companies).

To understand the essence and importance of “relevant” data, consider the following: the size of the combined data would likely be very large. “Relevant” data are a subset in terms of both time and content. For example, a sensor can operate correctly 99.99% of the time. That leaves 99.99% of the data not interesting, and only the remaining 0.01% of relevance. The challenge is to find that 0.01%. The content of the data are filtered as well. For example, if a sensor failure is detected as a result of discrepancy between self-vehicle sensor data and V2X data received from a particular vehicle X then V2X data received from all other vehicles is not relevant. Similarly, an accident is a short event, lasting only a few seconds. Relevant data will thus include only the short period before the accident, and only for the vehicles involved in the accident, i.e. the vehicles that triggered the events leading to the accident.

In other words: in known practice, vehicle data used for accident reconstruction and other use-cases is based on the information collected from onboard sensors, i.e. is only self-vehicle data. In contrast, this disclosure adds V2X data to self-vehicle data, and, for example in accident reconstruction use-cases, combines the self-vehicle data with the V2X data to achieve a more complete accident scene than provided only from a self-vehicle point-of-view. In the onboard self-vehicle sensors fail to provide correct data or provide false data, the added V2X data can be used to identify a sensor failure and to isolate only relevant data.

In various embodiments there are provided, in a self-vehicle generating self-vehicle data related to a use-case, apparatii comprising: a V2X communication unit configured to receive V2X data from another vehicle; a combined data processor configured to process the self-vehicle data and the V2X data into combined data and to extract relevant data from the combined data, the relevant data relevant to the use-case; and a cloud communication unit configured to transmit the relevant data to a cloud.

In some embodiments, the processor is further configured to create a relevant data log for logging the relevant data before transmitting the relevant data to the cloud. The relevant data log may be included in the apparatus or may reside in the cloud.

In some embodiments, the use-case includes an accident. In such embodiments, the relevant data log may include an accident log.

In some embodiments, the use-case includes self-vehicle sensor mismatch. In such embodiments, the relevant data log may include a false-negative log and a false-positive log.

In various embodiments there are provided, in a self-vehicle generating self-vehicle data related to a use-case, methods comprising: receiving V2X data from another vehicle; combining the self-vehicle data with the V2X data to obtain combined data; extracting relevant data from the combined data, the relevant data relevant to a use-case; and transmitting the relevant data to a cloud.

In some embodiments, a method further comprisesstoring the relevant data in a log in the self-vehicle before the transmission to the cloud.

In some embodiments involving an accident use-case, the storing the relevant data in a log includes creating an accident log that stores objects detected by self-vehicle sensors and other vehicle sensors and combining duplicate objects to prevent duplicate and confusing reporting of a same object.

In some embodiments involving a self-vehicle sensor mismatch use-case, the storing the relevant data in a log includes creating a false-negative log or a false positive log. In some embodiments, the sensor mismatch is identified if an object is detected by the self-vehicle but not by the another vehicle or vice-versa. In some embodiments, the sensor mismatch is identified if the another vehicle is not observed, contradicting a position of the another vehicle as transmitted in the V2X data.

### BRIEF DESCRIPTION OF THE DRAWINGS

Non-limiting examples of embodiments disclosed herein are described below with reference to drawings attached hereto that are listed following this paragraph. The drawings and descriptions are meant to illuminate and clarify embodiments disclosed herein and should not be considered limiting in any way. In the drawings:

FIG. 1 illustrates a flow chart of vehicular data enhancement using V2X, according to embodiments disclosed herein;

FIG. 2 illustrates a block diagram of an embodiment of an apparatus for vehicular data enhancement using V2X disclosed herein;

FIG. 3 illustrates a flow chart of identification of conditions for occurance of a use-case;

FIG. 4 illustrates in an example a flow chart of accident use-case data processing;

FIG. 5. illustrates an example of detection zones for use in an accident use-case;

FIG. 6 illustrates in an example a flow chart of sensor mismatch use-case data processing.

### DETAILED DESCRIPTION

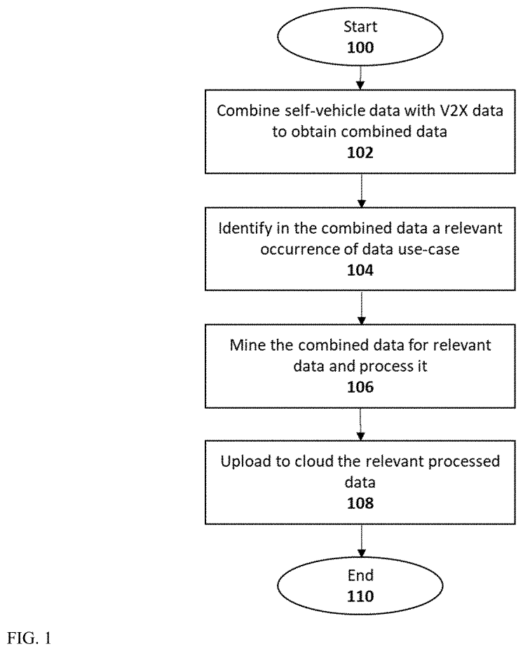

FIG. 1 illustrates a flow chart of vehicular data enhancement using V2X, according to embodiments disclosed herein. Operation starts periodically in step 100. Some events, like accidents, may trigger (require) high frequency data processing. Therefore, in an example, the flow chart operation period preferably equals a V2X update period, i.e. 100msec. In step 102, self-vehicle data are combined with V2X data to obtain combined data. In step 104, a relevant occurrence of data use-case is identified. To clarify, herein the terms “use-case” and “data use-case” are used interchangeably. That is, the combined data are scanned to check if a predetermined condition for occurence of a use-case is fulfilled, for example if there is an accident and or if there is a sensor mismatch, which, if fulfilled, indicates a use-case of the data. In step 106, the combined data are mined based on the use-case to extract relevant data fields, which are then processed according to the use-case to provide relevant data. In step 108, only the relevant data are uploaded to a cloud. The lowered amount of data uploaded reduces data cost, bandwidth requirement, and needed processing in the cloud. Operation ends at step 110.

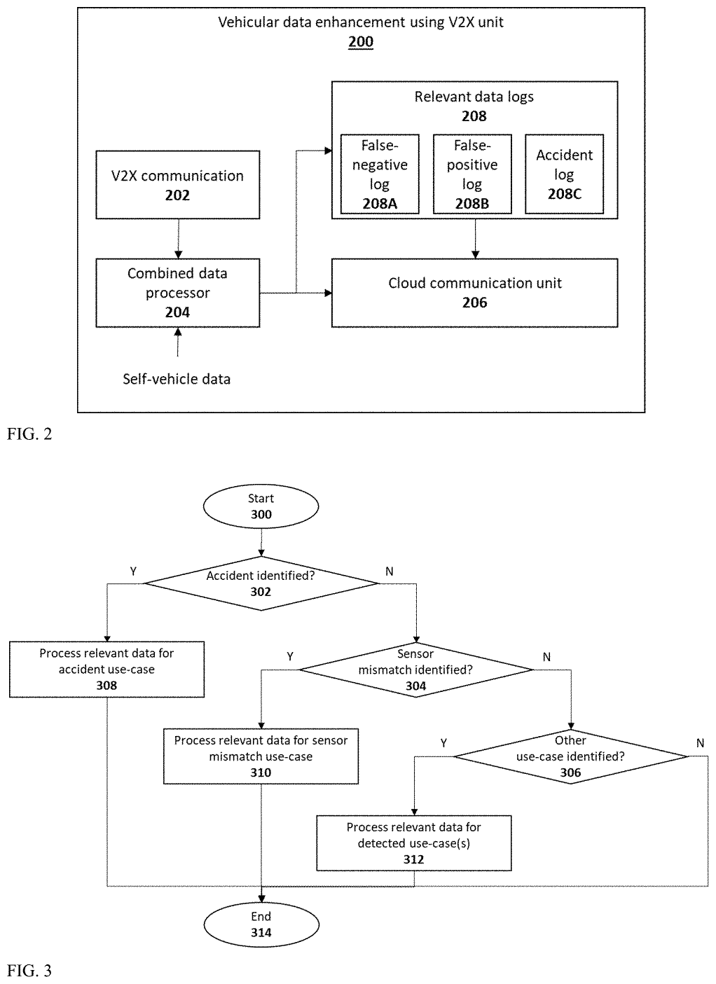

FIG. 2 illustrates a block diagram of an embodiment of an apparatus for vehicular data enhancement using V2X, numbered 200. The apparatus is installed and operated in a self-vehicle. Note that any vehicle that includes such apparatus may operate as a “self-vehicle”. Apparatus 200 comprises a V2X communication unit 202, a combined data processor 204 with added new functionalities over known vehicular data processors, a cloud communication unit 206. V2X communication unit 202 is configured to transmit information about the self-vehicle, to receive information from other vehicles and to transmit and receive detected objects of (i.e. objects detected by) vehicle sensors.

In some embodiments, apparatus 200 further comprises relevant data logs 208. Relevant data logs 208 may include a false-negative log 208A, a false-positive log 208B, and an accident log 208C. In some embodiments, the relevant data logs may be included in a cloud instead in the apparatus.

V2X messages received by V2X communication unit 202 are fed into combined data processor 204, which also receives the self-vehicle data. Combined data processor 204 performs the data processing and analysis described with reference to FIG. 1, using combined data. The analyzed data are mined such that only relevant data are stored, and all other data are ignored. In some embodiments, the relevant data are stored in an appropriate log 208 (i.e. one of 208A, 208B or 208C) before being sent to cloud communication unit 206, which uploads it to a cloud. In other embodiments, the relevant data may be sent directly after mining to the cloud communication unit, without storage in a log. The communication unit may be connected to the cloud using various types of communication protocols, for example using cellular communication, although WiFi or another communication protocol can be used as well.

FIG. 3 illustrates a flow chart of identification of conditions for occurance of a use-case, providing details of the operation in steps 104 and 106 of FIG. 1. Two exemplary (and in no way limiting) use-cases are accident reconstruction and sensor failure. Other use-case may benefit from methods and apparatus disclosed herein. Operation begins in step 300, when step 104 is called. Next, in step 302, a check is made if an accident is identified. An accident is identified (“Yes”) when for example a sudden powerful acceleration is detected for a short duration in one of the self-vehicle axes, or when an acceleration peak is uncorrelated with the vehicle movement, for example, when a major acceleration is detected while the vehicle is supposed to move at a stable speed. In contrast, an inflated airbag is not a condition for identifying an accident, since a light accident or an accident with a Vulnerable Road User (VRU) needs to be logged even if an airbag does not inflate. The accident may be a self-accident, with no other vehicle involved, or it may involve one or more other vehicles or road-users.

If the check is positive, the operation continues from step 308, where relevant data are processed for an accident use-case, as explained below. The operation then reaches an end 314. If the result of the check in step 302 is negative (“No”), i.e. if no accident is detected, the operation continues to step 304, where a check is made if a sensor mismatch is identified. In one example, a sensor mismatch is identified if a detected object is detected by the self-vehicle but not by another vehicle, or vice-versa when an object is detected by another vehicle but not by the self-vehicle. In another example, a mismatch is identified if another vehicle is not observed, contradicting its position as transmitted via V2X. The mismatch is checked only for detected objects within 150 meters range from a self or other vehicle, to render the check relevant. If Yes, i.e. if a mismatch is identified, the operation continues to step 310, where the relevant data are processed for a sensor mismatch use-case, as explained below. From there, the operation reaches an end in step 314. If the result of the check in step 304 is No, and a sensor mismatch is not detected, the operation continues to step 306, where checks of identification of conditions for occurance of one or more additional use-cases are performed per use-case. If such additional use-case checks are positive, then additional actions 312 may be defined for the specific use-cases. Otherwise, the operation ends at step 314.

The data are different per use-case. For sensor mismatch, the relevant data spans only the period during which the mismatch is detected.

False-negative log 208A contains the location, speed and heading of the V2X detected object, and the raw data of the self-vehicle sensor that should have detected the object. False-positive log 208B contains the location, heading and sensor parameters of vehicles that did not detect the object, along with the raw data of the self-vehicle sensor that detected the object. For accident reconstruction, log 208C spans only N seconds before the accident, and it contains all self-vehicle data, the location, speed, heading, yaw rate and acceleration of other vehicles in the scenary, and the superposition of field-of-view of all V2X vehicles in accident vicinity .

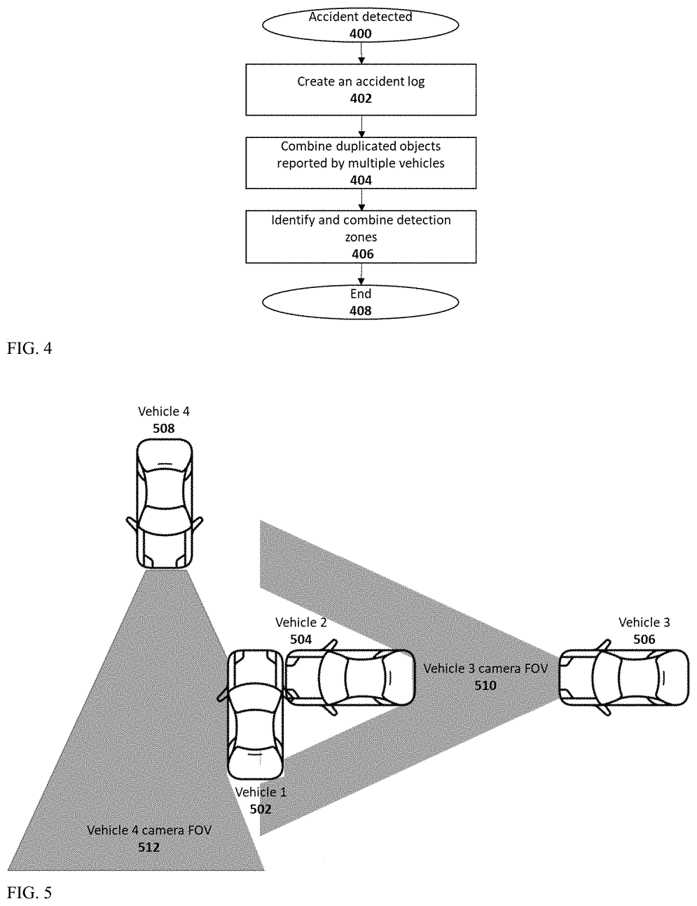

FIG. 4 illustrates in an example a flow chart of accident use-case data processing, providing details of the operation in step 308. Operation begins at step 400, when an accident is detected and step 308 is called. In step 402, a dedicated accident log (208C) is created, storing all objects detected by vehicle self-sensors, the V2X data, and objects detected by other V2X vehicles in the vicinity of the self-vehicle in the last N (for example 10) seconds. In step 404, duplicate objects are combined to prevent duplicate and confusing reporting of a same object. An object should be stored only once in accident log 208C. If the same object was reported N different times by N vehicles, then a single averaged entry into log 208C is kept for that object. Duplication of objects may occur when data on an object is received from two or more sensors of any kind from other vehicle basic V2X message reception, or when an object is detected by a V2X vehicle supporting a sensor sharing message. In case of duplication, the location, speed, and other properties of the object are calculated as the weighted average of the values perceived by all vehicles using a confidence value transmitted as part of a V2X message as a weight factor. Each parameter has a confidence value to asses its reliability. The calculated values are stored in log 208C. Next, in step 406, detection zones are identified and combined. Detection zones are defined as the areas in which vehicle sensors, including self-vehicle sensors and other other-vehicle applying sensor sharing, detect objects. The detection zones are typically represented as polygons. Each vehicle detection zone is aligned to the vehicle frame, in other words, shifted based on the heading. A detection zone considers each sensor range and field of view (FOV), i.e. excludes the areas that are hidden by other objects After respective FOVs are determined, the detection zones are combined, since some may overlap. Since all vehicle sensors, except V2X, operate only in line-of-sight, any object behind another object cannot be observed. Thus, a polygon has to exclude all areas after the first line-of-sight object. Another aspect is combining detection zones of different vehicles. For example, two vehicles side-by-side will have their detection zones mostly overlapping. Next, the operation ends at step 408.

To summarize, the process described in FIG. 4 collects detected objects from all nearby vehicles, cleans duplicated objects and marks the detection zones for which information is available to provide two new types of complete relevant accident data to be uploaded to the cloud. In some example, in further actions the uploaded relevant data may be used by insurance companies and/or by law authorities to determine for example the party liable in an accident.

FIG. 5. illustrates an example of detection zones for use in step 406 above of the accident use-case. An accident involves a first vehicle 502, and a second vehicle 504. Vehicle 502 has V2X, but vehicle 504 does not. Therefore, for full accident reconstruction, the progress of vehicle 504 has not been transmitted by the vehicle itself and needs to be obtained from another vehicle that observed it. A vehicle 506 having V2X with sensor sharing observes vehicle 504 with its front camera, with a FOV in a detection zone 510. Vehicle 502 receives the sensor sharing messages of vehicle 506 describing vehicle 504. A fourth vehicle 508 with a FOV in a detection zone 512 also supports V2X with sensor sharing. FOV 510 is obstructed by vehicle 504. FOV 512 is slightly obstructed by vehicle 502. The polygons of 510 and 512 are combined, so that once the reconstructed accident sequence is replaced, a viewer can understand what was observed and what could be potentially missing from the picture.

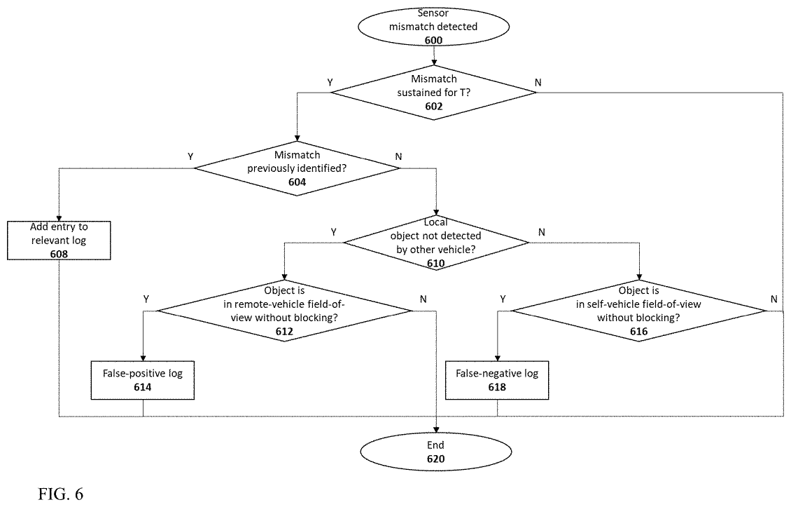

FIG. 6 illustrates in an example a flow chart of sensor mismatch use-case data processing, providing details of the operation in step 310. The operation begins at step 600 after step 310 is called. In step 602, a check is made if the mismatch has is sustained for a time period T, where T may be typically 200 msec or 300 msec. The reason for the check is to ignore short-term mismatches resulting from different sensor detection latencies and communication latency, and instead focus only on sustainable differences. If the result of the check is No, and the mismatch is short-term, then operation ends at step 620. Otherwise, the operation continues to step 604, where a check is made to see if the mismatch has been previously identified. If Yes, there is no need to continue with further steps in the flow chart, since such steps are calculation intensive, and operation continues to step 608, where the latest data are added to the relevant log (either false-positive or false-negative), which previously added the mismatch. Otherwise (No in step 604), the operation continues to step 610.

In step 610, a check is made if an object is detected by the self-vehicle but not detected by another vehicle, i.e. if the mismatch identified in step 304 resulted from this case and not the opposite one. If the result of the check is positive (Yes), the operation continues from step 612. A check is made if the object detected by the self-vehicle is in the other vehicle FOV without blocking, i.e. if the other vehicle should have detected the object. If the self-vehicle does not know the other vehicle FOV, since that FOV was not shared in a sensor-sharing message, then the other vehicle is assumed to include only a front camera. The check is performed by placing the object relative to the other vehicle frame using a local dynamic map in the self-vehicle. If the object is not covered by any sensor detection area (FOV), either because the distance between the vehicle and the object is beyond the sensor detection range, or if the sensor FOV is too narrow, then the other vehicle could not have detected the object. Also, if a virtual line drawn between the object and the other vehicle crosses any other object, then the other vehicle could not have detected the object. If the result of the check is negative, and the object isn't supposed to be detected, the operation ends at step 620. If the check is positive (No), and the object is supposed to be detected, then the operation continues from step 614, where the self-vehicle sensor raw data are added to false-positive log 208B, where later a further analysis, typically performed by a human, can determine if indeed the object was falsely detected by the self-vehicle. From there, the operation ends at step 620.

If the result of the check in step 610 is No, meaning the object was detected by another vehicle, while not detected by the local vehicle, the operation continues from step 616. A check is made if the object is in the self-vehicle's FOV without blocking,i.e. if the self-vehicle should have detected the object. The same logic of step 612 is applied. If the result of the check in step 616 is negative, and the object is not supposed to be detected by the self-vehicle, the operation ends at step 620. If the result of the check is positive, and the object is supposed to be detected, then the operation continues from step 618, where the raw information is added to false-negative log 208A, where further analysis, typically performed by a human, can determine if indeed the object was falsely missed by self-vehicle. From there, the operation ends at step 620.

It is appreciated that certain features of the presently disclosed subject matter, which are, for clarity, described in the context of separate examples, may also be provided in combination in a single example. Conversely, various features of the presently disclosed subject matter, which are, for brevity, described in the context of a single example, may also be provided separately or in any suitable sub-combination.

Unless otherwise stated, the use of the expression “and/or” between the last two members of a list of options for selection indicates that a selection of one or more of the listed options is appropriate and may be made.

It should be understood that where the claims or specification refer to “a” or “an” element, such reference is not to be construed as there being only one of that element.

Some stages of the aforementioned methods may also be implemented in a computer program for running on a computer system, at least including code portions for performing steps of a the relevant method when run on a programmable apparatus, such as a computer system or enabling a programmable apparatus to perform functions of a device or system according to the disclosure. Such methods may also be implemented in a computer program for running on a computer system, at least including code portions that make a computer execute the steps of a method according to the disclosure.

While this disclosure has been described in terms of certain examples and generally associated methods, alterations and permutations of the examples and methods will be apparent to those skilled in the art. The disclosure is to be understood as not limited by the specific examples described herein, but only by the scope of the appended claims.

1. In a self-vehicle generating self-vehicle data related to a use-case, an apparatus, comprising:
a) a vehicle-to-everything (V2X) communication unit configured to receive V2X data from another vehicle;
b) a combined data processor configured to process the self-vehicle data and the V2X data into combined data and to extract relevant data from the combined data, the relevant data relevant to the use-case; and
c) a cloud communication unit configured to transmit the relevant data to a cloud.

2. The apparatus of claim 1, wherein the processor is further configured to create a relevant data log for logging the relevant data before transmitting the relevant data to the cloud.

3. The apparatus of claim 1, wherein the use-case includes an accident.

4. The apparatus of claim 3, wherein the relevant data log includes an accident log.

5. The apparatus of claim 1, wherein the use-case includes self-vehicle sensor mismatch.

6. The apparatus of claim 5, wherein the relevant data log includes a false-negative log and a false-positive log.

7. In a self-vehicle generating self-vehicle data, a method, comprising:
a) receiving V2X data from another vehicle;
b) combining the self-vehicle data with the V2X data to obtain combined data;
c) extracting relevant data from the combined data, the relevant data relevant to a use-case; and
d) transmitting the relevant data to a cloud.

8. The method of claim 7, further comprising storing the relevant data in a log in the self-vehicle before the transmission to the cloud.

9. The method of claim 7, wherein the use-case includes an accident.

10. The method of claim 8, wherein the use-case includes an accident.

11. The method of claim 8, wherein the storing the relevant data in a log includes creating an accident log that stores objects detected by self-vehicle sensors and other vehicle sensors and combining duplicate objects to prevent duplicate and confusing reporting of a same object.

12. The method of claim 7, wherein the use-case includes a self-vehicle sensor mismatch.

13. The method of claim 8, wherein the use-case includes a self-vehicle sensor mismatch.

14. The method of claim 13, wherein the storing the relevant data in a log includes creating
a false-negative log and a false positive log for storing sensor mismatch data.

15. The method of claim 14, wherein the sensor mismatch is identified if an object is detected by the self-vehicle but not by the another vehicle or vice-versa.

16. The method of claim 14, wherein the sensor mismatch is identified if the another vehicle is not observed, contradicting a position of the another vehicle as transmitted in the V2X data.
